(19) United States
(12) Patent Application Publication
(10) Pub. No.: US 2026/0184375 A1
(43) Pub. Date: Jul. 2, 2026

(54) OFF-ROAD VEHICLE

(71) Applicant: Polaris Industries Inc., Medina, MN (US)

(72) Inventors: Andrew C. Schleif, Stacy, MN (US); Paul W. Barton, Warwickshire (GB); Ralph W. Lauzze, III, Hugo, MN (US)

(21) Appl. No.: 19/273,988

(22) Filed: Jul. 18, 2025

Related U.S. Application Data
(63) Continuation of application No. 18/209,294, filed on Jun. 13, 2023, now Pat. No. 12,384,464.
Application No. 18/209,294 is a continuation of application No. 16/875,494, filed on May 15, 2020, now Pat. No. 11,691,674.

(51) Int. Cl. B62D 21/18; B60K 5/00; F02B 5/00

(52) U.S. Cl. CPC B62D 21/183; B60K 5/00; F02B 5/00

(57) ABSTRACT

A utility vehicle comprising a frame, a body supported by the frame, a seating area supported by the frame, front and rear ground engaging members supporting the frame and the body, and a powertrain drivingly coupled to the front and rear ground engaging members, the powertrain including an engine having a cylinder block having a plurality of cylinders, a cylinder head removably coupled to the cylinder block, a crankcase having a first portion and a second portion, the first portion of the crankcase being removably coupled to the cylinder block, and at least one gasket positioned between the cylinder block and the first portion of the crankcase, the at least one gasket configured to individually seal each of the plurality of cylinders relative to the first portion of the crankcase.

### PRIORITY APPLICATIONS

This application is a continuation of U.S. patent application Ser. No. 18/209,294, filed Jun. 13, 2023, which application is a continuation of U.S. patent application Ser. No. 16/875,494, filed May 15, 2020, now U.S. Pat. No. 11,691,674, the contents of all which are herein incorporated by reference in its entirety.

### FIELD OF THE INVENTION

The present invention relates to off-road vehicles including all-terrain vehicles (“ATVs”) or utility vehicles (“UTVs”).

### BACKGROUND OF THE INVENTION

Generally, UTVs or ATVs are used to carry one or more passengers and a small amount of cargo over a variety of terrains. Current ATVs and UTVs are typically provided with engines having a unitary engine block housing a plurality of cylinders and a portion of a crankcase. However, for engine modularity purposes, a need exists for an engine in a UTV or ATV that has a cylinder block separate from but sealingly engaged with the portion of the crankcase.

### SUMMARY OF THE INVENTION

In one embodiment of the disclosure, a utility vehicle comprises a frame, a body supported by the frame, a seating area supported by the frame, front and rear ground engaging members supporting the frame and the body, and a powertrain drivingly coupled to the front and rear ground engaging members. The powertrain includes an engine having a cylinder block having a plurality of cylinders, a cylinder head removably coupled to the cylinder block, and a crankcase having a first portion and a second portion. The first portion of the crankcase is removably coupled to the cylinder block, and at least one gasket is positioned between the cylinder block and the first portion of the crankcase. The at least one gasket is configured to individually seal each of the plurality of cylinders relative to the first portion of the crankcase.

In another embodiment of the disclosure, an engine for a utility vehicle comprises a cylinder block having a plurality of cylinders, a cylinder head removably coupled to the cylinder block, and a crankcase having a first portion and a second portion. The first portion of the crankcase is removably coupled to the cylinder block. Each of the plurality of cylinders is individually sealed with the first portion of the crankcase via at least one sealing member.

### BRIEF DESCRIPTION OF THE DRAWINGS

FIG. 1 shows a front left perspective view of a vehicle of the present disclosure;

FIG. 2 shows a right rear perspective view of the vehicle of FIG. 1;

FIG. 3 shows a left elevational side view of the vehicle of FIG. 1;

FIG. 4 shows a right elevational side view of the vehicle of FIG. 1;

FIG. 5 shows a top plan view of the vehicle of FIG. 1;

FIG. 6 shows a front elevational view of the vehicle of FIG. 1;

FIG. 7 shows a rear elevational view of the vehicle of FIG. 1;

FIG. 8 shows a schematic view of a powertrain of the vehicle of FIG. 1;

FIG. 9 shows a first perspective view of an engine of the vehicle of FIG. 1;

FIG. 10 shows a second perspective view of the engine of FIG. 9;

FIG. 11 shows a side plan view of a fuel injection assembly of the vehicle of FIG. 1 coupled to an air intake and an engine of a powertrain of the vehicle of FIG. 1;

FIG. 12 shows a cross-sectional view of the fuel injection assembly, air intake, and engine of FIG. 11 taken along line 12-12 of FIG. 11;

FIG. 13 shows a perspective view of the engine of FIG. 9 with a cam cover, a cylinder head, and a coolant assembly of the engine removed;

FIG. 14 shows an exploded view of a portion of the engine of FIG. 13;

FIG. 15 shows a cross-sectional view of a portion of the engine of FIG. 13 taken along line 15-15 of FIG. 13;

FIG. 16 shows a perspective view of a starter motor, a balance shaft, an oil pump, a water pump, a crankshaft and an oil pan of the engine of FIG. 9;

FIG. 17 shows a side plan view of the starter motor, the balance shaft, and the crankshaft of FIG. 16;

FIG. 18 shows an exploded view of the starter motor, the balance shaft, and the crankshaft of FIG. 17;

FIG. 19 shows an exploded view of the water pump and the oil pump of FIG. 16;

FIG. 20 shows a perspective view of a lubrication system of the engine of FIG. 9;

FIG. 21 shows an exploded view of the lubrication system of FIG. 20;

FIG. 22 shows a cross-sectional view of lubrication system of FIG. 20 taken along line 22-22 of FIG. 20;

FIG. 23A is a detailed cross-sectional view of a scavenge pump of the lubrication system of FIG. 22 when the vehicle of FIG. 1 is tilted in a first direction; and

FIG. 23B shows a detailed cross-sectional view of the scavenge pump of the lubrication system of FIG. 22 when the vehicle of FIG. 1 is tilted in a second direction.

### DETAILED DESCRIPTION OF THE DRAWINGS

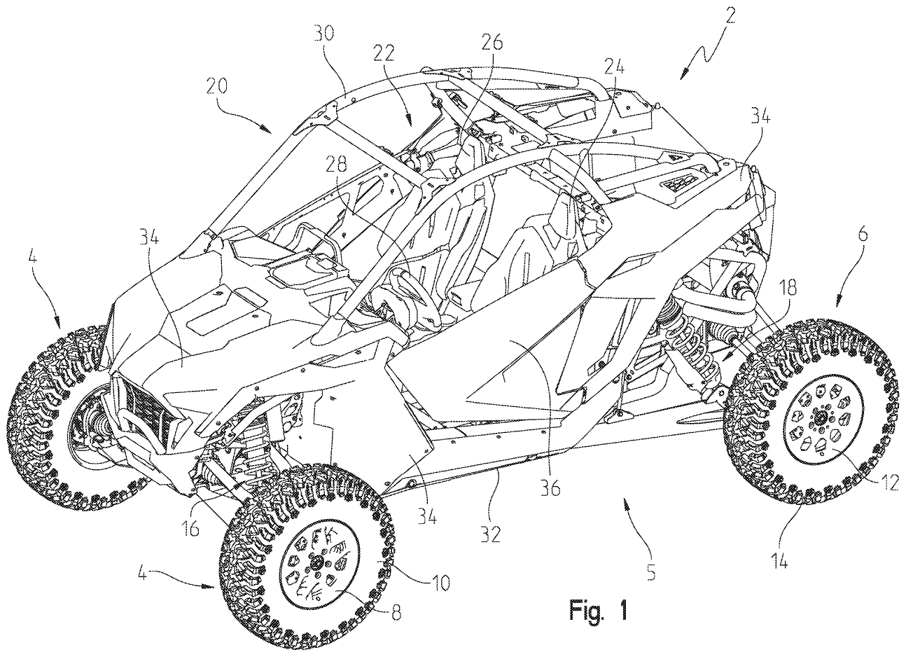

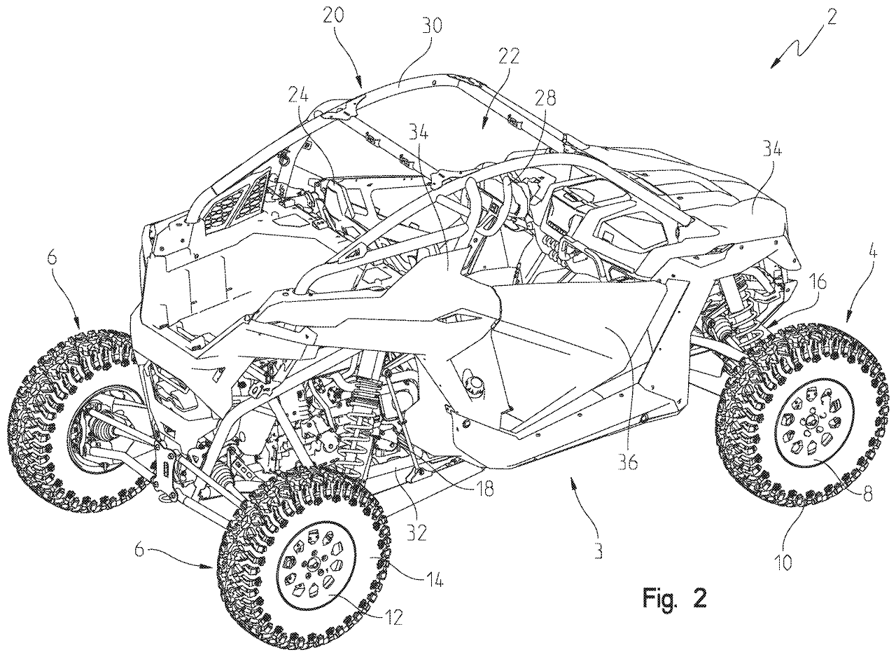

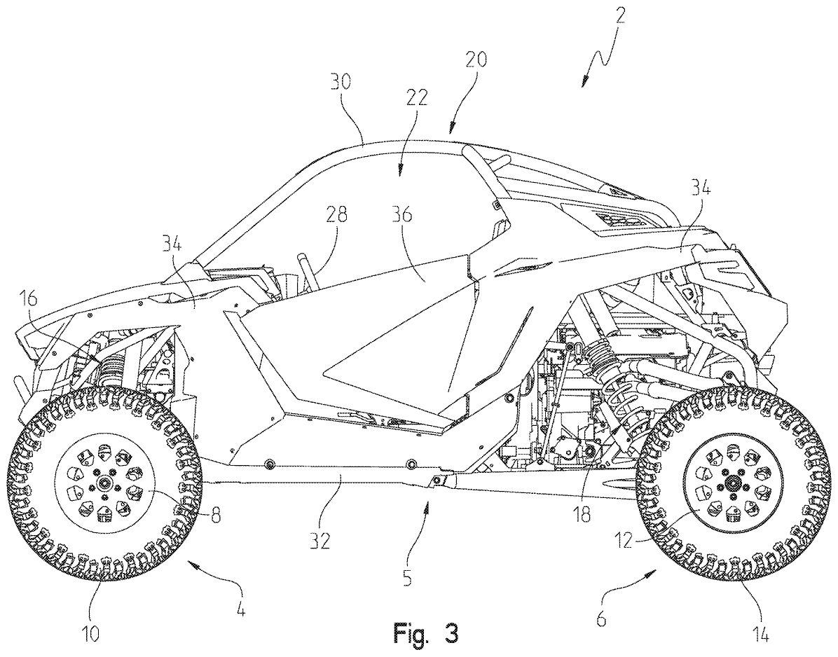

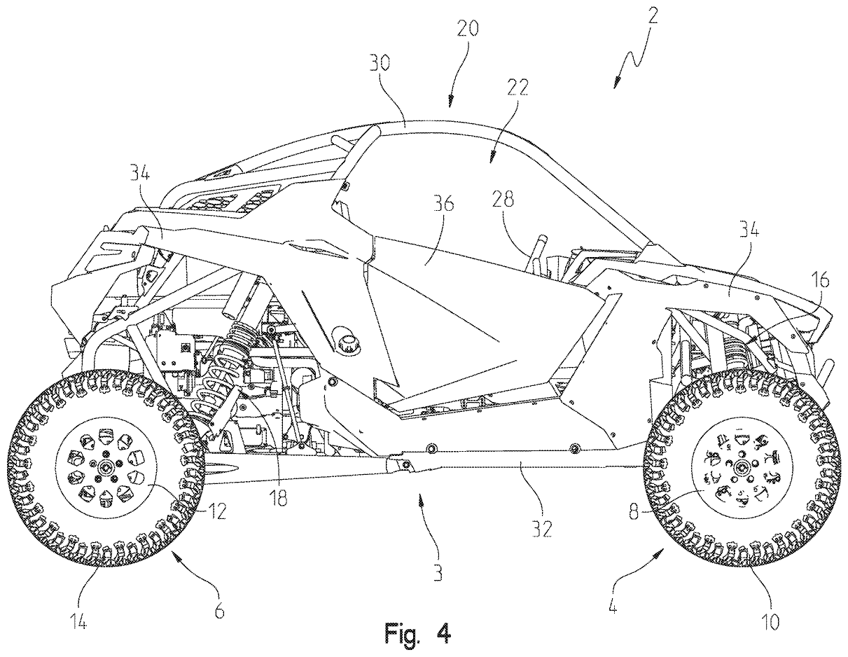

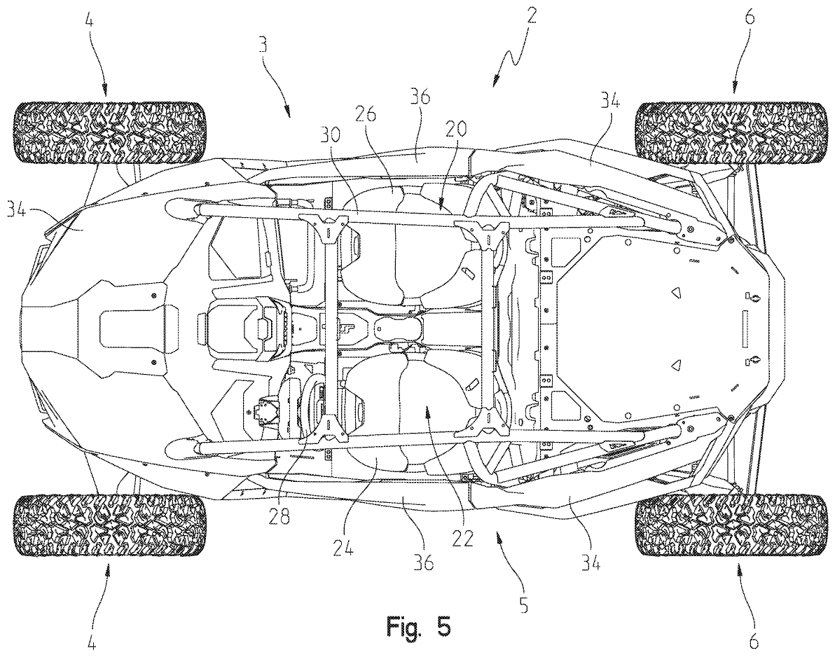

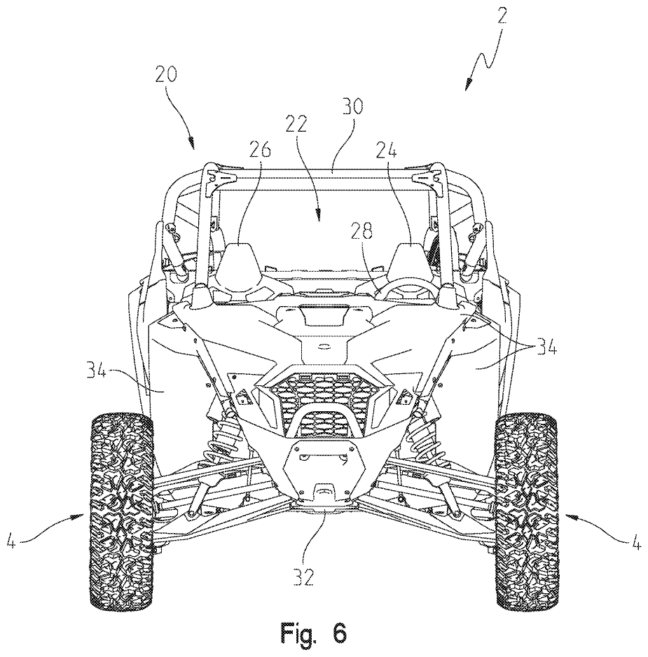

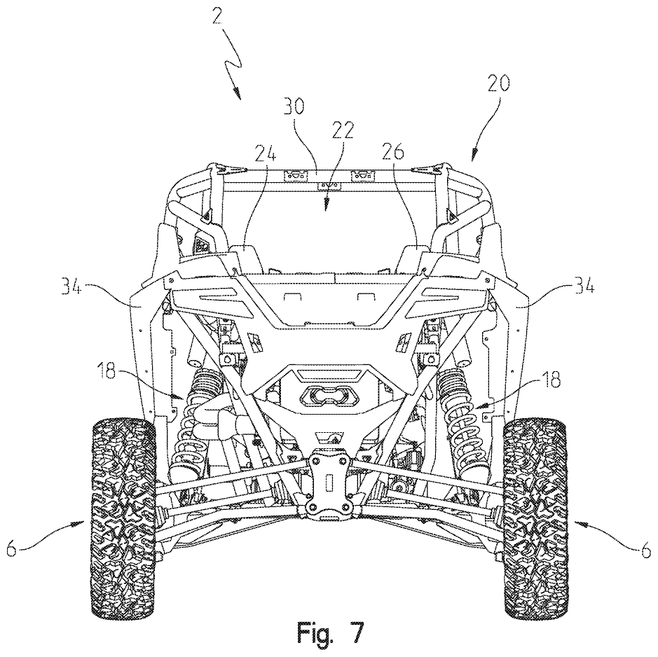

With reference to FIGS. 1-7, the vehicle of the present invention will be described. As shown, the vehicle is generally depicted as reference number 2 which includes front ground engaging members 4 and rear ground engaging members 6. Front ground engaging members 4 are comprised of wheels 8 and tires 10, and rear ground engaging members 6 are comprised of wheels 12 and tires 14. Ground engaging members 4 and 6 support a vehicle frame, which is shown generally at 20, through front and rear suspension assemblies 16 and 18.

Vehicle frame 20 supports a seating area 22 comprised of a driver's seat 24 and a passenger seat 26. Vehicle 2 further includes a steering assembly for steering front ground engaging members 4 whereby the steering assembly includes a steering wheel 28. Frame 20 of vehicle 2 is comprised of a cab frame 30 that generally extends over the seating area 22, and a lower frame portion 32 positioned below and supporting cab frame 30. Frame 20 is configured to support a plurality of body panels 34 and/or doors 36.

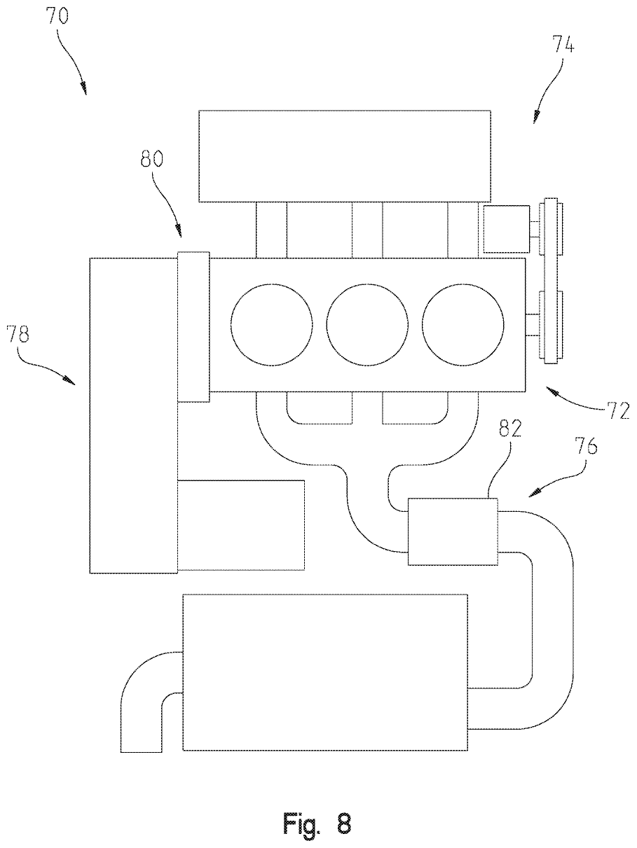

With reference now to FIG. 8, vehicle 2 further includes a powertrain assembly 70 for providing power to ground engaging members 4 and 6 of vehicle 2. Powertrain assembly 70 generally comprises an engine 72, an air intake assembly 74 providing air to engine 72, an exhaust assembly 76 routing exhaust from engine 72 out of vehicle 2, a transmission 78 coupled to engine 72, and a drivetrain (not shown) coupled to transmission 78. Additional details relating to vehicle 2 including powertrain 70 may be found in U.S. patent application Ser. No. XX/XXX,XXX (Attorney Docket Number PLR-15-29110.01P-US), filed concurrently with the present application, the subject matter of which is incorporated herein by reference.

Still referring to FIG. 8, in various embodiments, powertrain assembly 70 may further include a starter clutch 80 removably coupled between engine 72 and transmission 78 to allow a starter motor, which may be in constant meshed engagement with starter clutch 80, to crank or start engine 72. Starter clutch 80 is generally sealingly coupled to engine 72 such that starter clutch 80 may receive lubricant from engine 72. Decoupling starter clutch 80 from engine 72 and transmission 78 allows for a more modular engine in that various components of powertrain assembly 70 may be used in different embodiments and orientations due to ability to couple and decouple components from each other, depending on the application on vehicle 2 and the requirements of powertrain assembly 70. Furthermore, in various embodiments, powertrain assembly 70 may include a turbocharger 82 at least fluidly coupled with exhaust assembly 76.

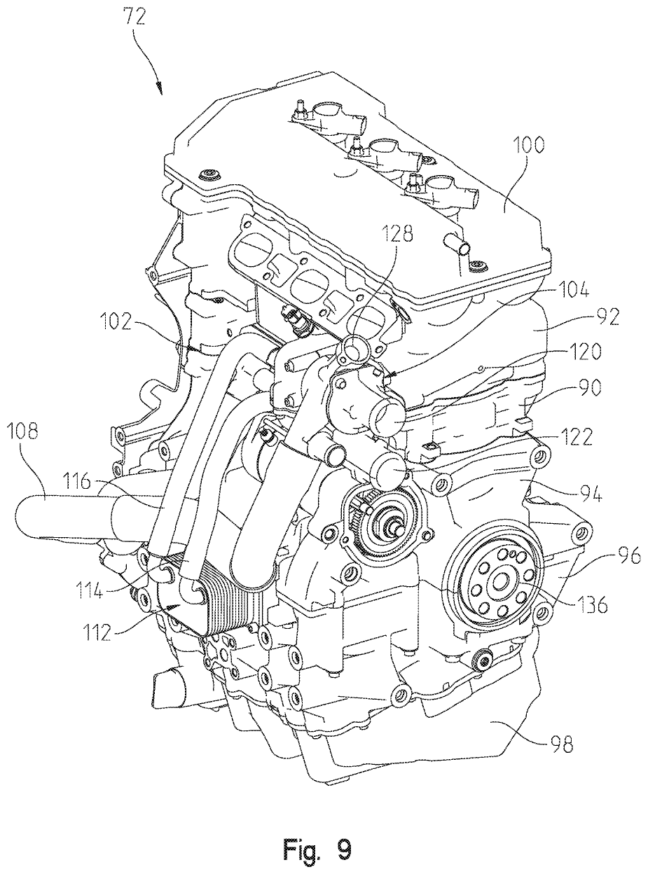

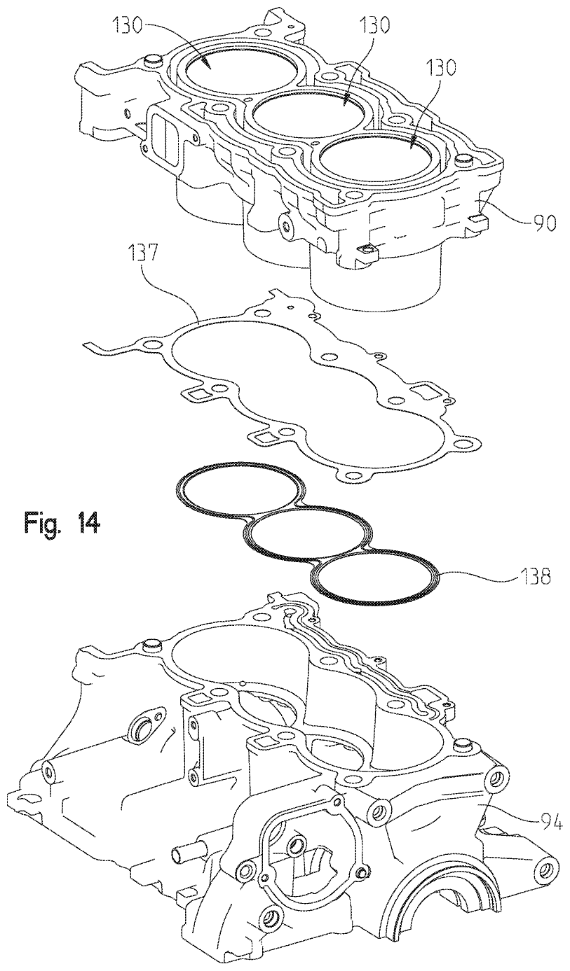

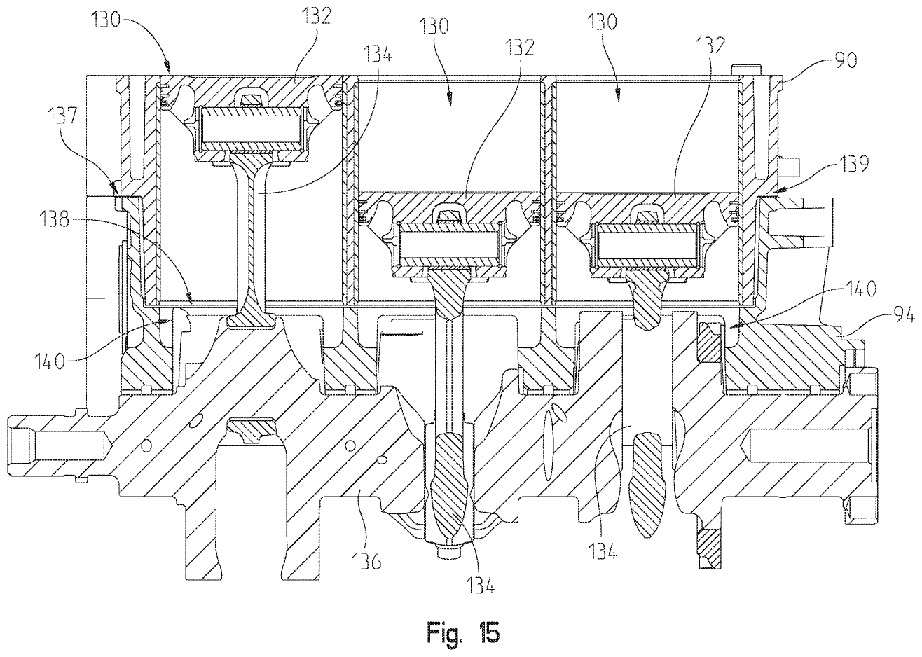

Referring now to FIGS. 9-15, engine 72 of powertrain assembly 70 generally includes a cylinder block 90, a cylinder head which includes an intake port 92 and is coupled to cylinder block 90, a first crankcase portion 94 coupled to cylinder block 90, a second crankcase portion 96 coupled to first crankcase portion 94, an oil pan 98 coupled to second crankcase portion 96, a valve or cam cover 100 depending on the location of valves and cams within engine 72 coupled over intake port 92, and a coolant assembly 102. Coolant assembly 102 may be configured to extend along a side of engine 72 from intake port 92 to second crankcase portion 94. In various embodiments, intake port 92 is positioned above cylinder block 90 and cylinder block 90 itself is positioned above first crankcase portion 94. First crankcase portion 94 is positioned above second crankcase portion 96 and second crankcase portion 96 is positioned above oil pan 98.

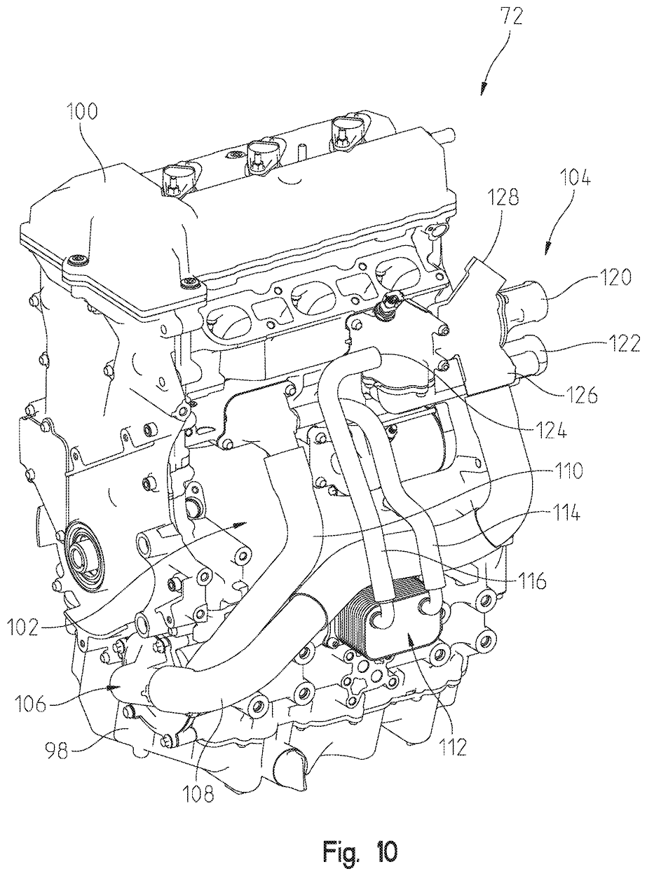

With reference to FIGS. 9 and 10, coolant assembly 102 generally includes a coolant manifold 104, a water pump 106 (FIG. 10), a water pump inlet conduit 108 coupling coolant manifold 104 to water pump 106, a water pump outlet conduit 110 (FIG. 10) coupling water pump 106 to engine 72, an oil cooler 112, an oil cooler outlet conduit 114 coupling oil cooler 112 to coolant manifold 104, and an oil cooler inlet conduit 116 coupling engine 72 to oil cooler 112. Coolant manifold 104 generally includes a first inlet 120 configured to receive coolant from a radiator (not shown), a first outlet 122 configured to provide heated coolant to the radiator, a second inlet 124 configured to receive heated coolant from oil cooler 112, a second outlet 126 configured to provide coolant to water pump 106, and a bleed outlet 128. In various embodiments, a thermostat (not shown) may be controlled with return, heated coolant from the radiator.

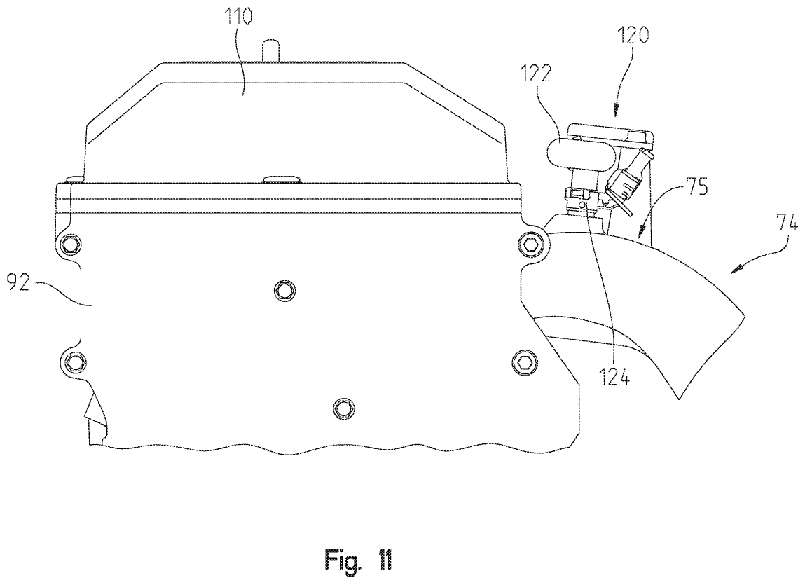

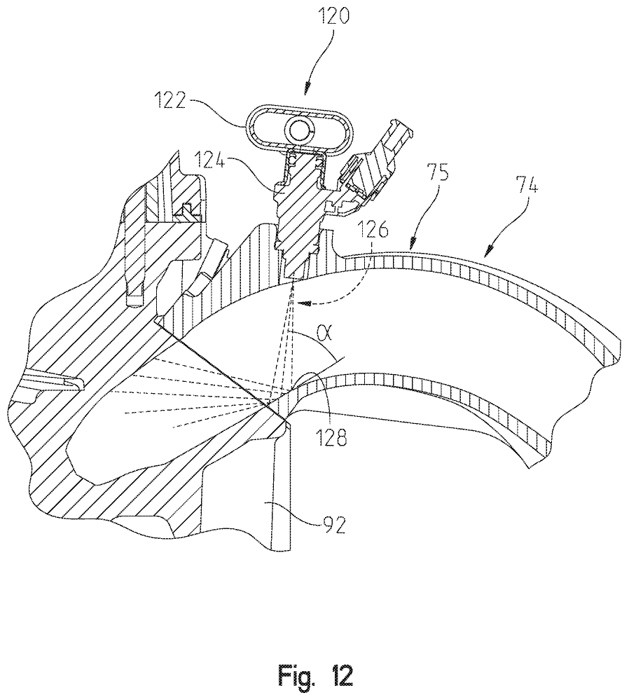

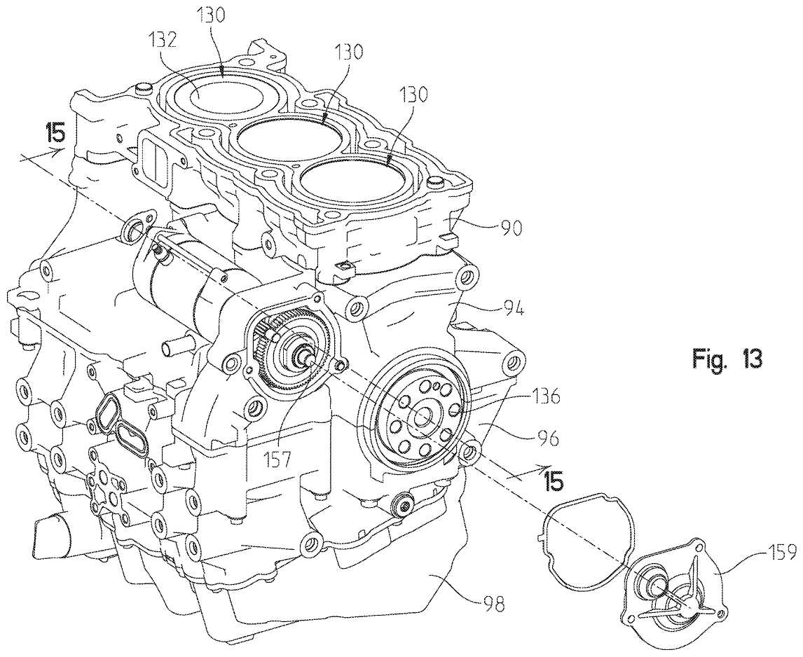

Referring now to FIGS. 11 and 12, powertrain assembly 70 further includes a fuel injection assembly 120. Fuel injection assembly 120 generally includes a fuel rail 122 and at least one fuel injector 124. In general, fuel injector assembly 120 includes one fuel injector 124 for each cylinder 130 (FIG. 13) of engine 72. Fuel injector(s) 124 are positioned along intake assembly 74 to direct a fuel stream 126 downward such that fuel stream 126 contacts an opposing interior wall 128 of intake assembly 74 and bounces at an angle a into intake port 92. More particularly, opposing interior wall 128 is generally opposite the location of fuel injector 124 such that fuel injector 124 is positioned at one portion of an intake manifold 75 of intake assembly 74 and opposing interior wall 128 is positioned approximately 180° from the location of fuel injector 124. In various embodiments, angle a may be between 30 degrees and 70 degrees. In the illustrative embodiment, angle a is approximately 45 degrees. By hitting wall 128 substantially straight on such that fuel stream 126 defines a linear stream that first contacts wall 128 before contacting any other portion of intake manifold 75, fuel stream 126 hits wall 128 and increases the atomization of fuel stream 126. Fuel stream 126 atomizes better since the entire fuel stream 126 hits wall 128 ensuring full stream 126 atomizes rather than only a portion of fuel stream 126. In general, fuel injector assembly 120 is positioned below a top of engine 72 for protection.

With reference now to FIGS. 13-15, engine 72 generally includes a plurality of cylinders 130, illustratively three but any number of cylinders 130 may be provided, a piston 132 positioned within each cylinder 130, and a connecting rod 134 coupling each piston 132 to a crankshaft 136. Cylinders 130 are generally positioned within cylinder block 90 which is sealingly coupled to and positioned above first crankcase portion 94 with a gasket 138. In various embodiments, gasket 138 is configured such that each cylinder 130 is individually sealed with first crankcase portion 94 at a lowermost end of cylinder block 90. In various embodiments, cylinder block 90 may be sealingly coupled above first crankcase portion 94 with an additional gasket 137 positioned above gasket 138 and between an uppermost end of first crankcase portion 94 and a lip 139 of cylinder block 90. In this way, each cylinder 130 is sealed from each other such that fluid does not flow between cylinders 130.

Crankshaft 136 is generally positioned within first and second crankcase portions 94 and 96, and connecting rods 134 reciprocate within crank bays 140 within first and second crankcase portions 94 and 96 and cylinders 130. Gasket 138 seals individual crank bays 140 to prevent windage created by the reciprocation of connecting rods 134 within crank bays 140 from passing between crank bays 140.

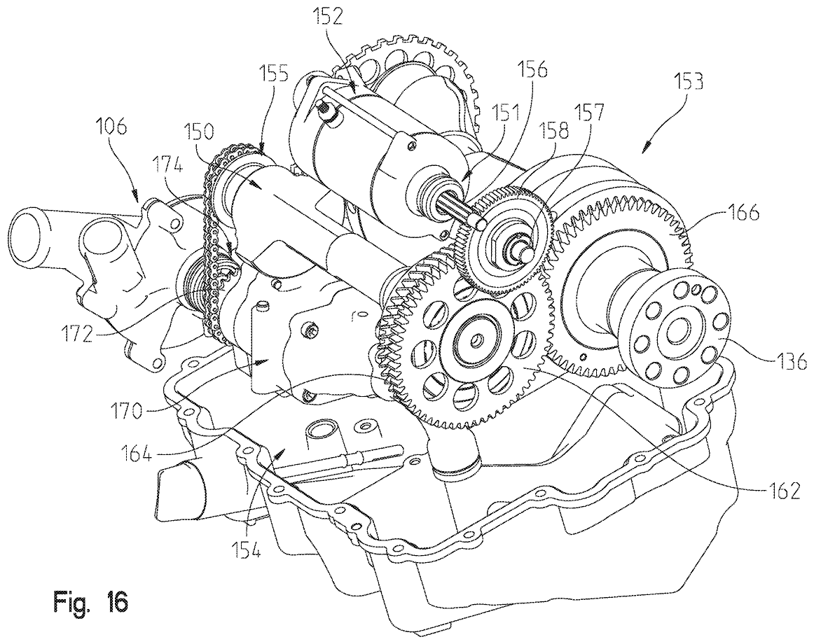

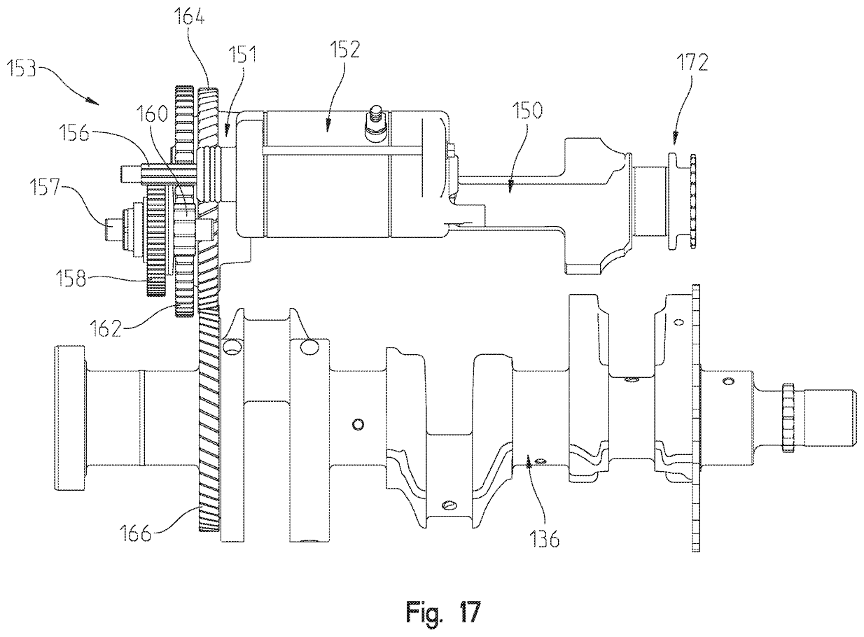

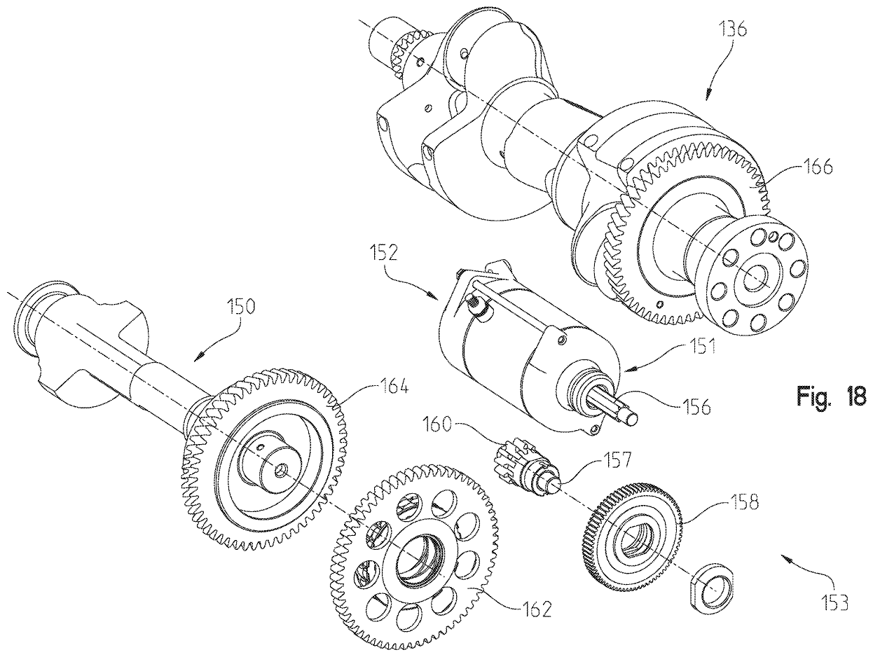

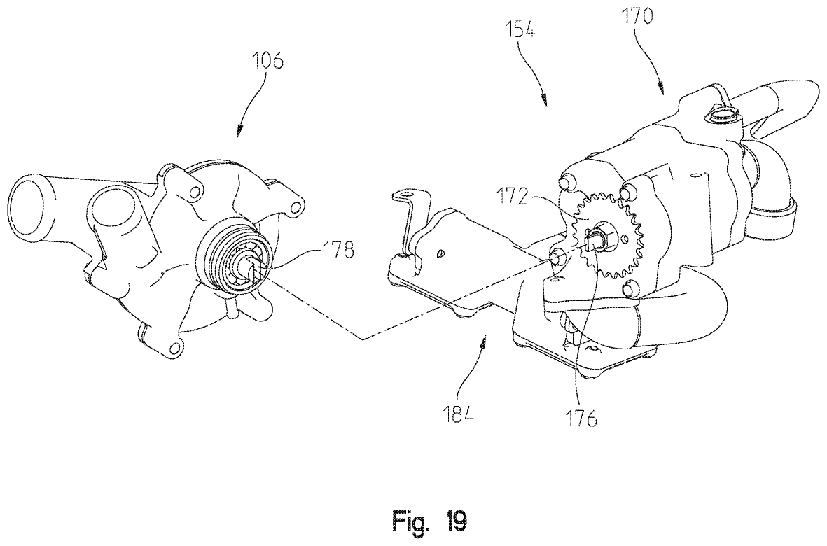

Referring now to FIGS. 16-19, engine 72 may further include a balance shaft 150 and a starter motor 152 for cranking or starting engine 72. In various embodiments, starter motor 152 and balance shaft 150 are coupled to crankshaft 136 such that crankshaft 136 is started by balance shaft 150. For example, and as shown in FIGS. 16-19, crankshaft 136 may be started by balance shaft 150 via a gear assembly 153. Gear assembly 153 generally includes a starter gear 156 coupled to a first end 151 of starter motor 152 which is meshed with a first transfer gear 158 coupled to a shaft 157, which extends between first crankcase portion 94 and a cover 159 (FIG. 13) coupled to first crankcase portion 94. First transfer gear 158 in turn is fixedly coupled to a second transfer gear 160 (FIGS. 18 and 19) which may also be coupled to shaft 157 and positioned between first crankcase portion 94 and cover 159. In this way, gears 158, 160 may rotate together on shaft 157 such that when starter motor 152 drives gear 158, gear 160 drives rotation of a gear 162, as disclosed further herein. In various embodiments, first transfer gear 150 is a torque limiting gear that limits any backfire torque engine 72 sees. Second transfer gear 160 in turn is meshed with an outer gear 162 of balance shaft 150 which is coupled to an inner gear 164 of balance shaft 150 via a one-way or sprag clutch such that outer gear 162 is fixedly coupled to inner gear 164 in a first direction and rotatably coupled to inner gear 164 in a second direction. Inner gear 164 of balance shaft 150, which is fixedly coupled to balance shaft 150, in turn is meshed with a gear 166 of crankshaft 136. In this way, crankshaft 136 may be started by balance shaft 150 via gear assembly 153.

With reference to FIGS. 16 and 19, engine 72 generally further includes a lubrication assembly 154 coupled to balance shaft 150 such that balance shaft 150 drives an oil pump 170 of lubrication assembly 154. For example, and as shown in FIG. 16, a second end 155 of balance shaft 150 may be coupled to a gear 172 of oil pump 170 via a chain 174 such that rotation of balance shaft 150 drives oil pump 170. In various embodiments, oil pump 170 is coupled directly to water pump 106 such that rotation of gear 172 of oil pump 170 drives water pump 106. For example, and as shown in FIG. 19, oil pump 170 may include a protrusion or key 176 fixedly coupled to gear 172 which is received within an indentation or opening 178 in water pump 106 such that rotation of protrusion 176 is transferred to water pump 106 through indentation 178.

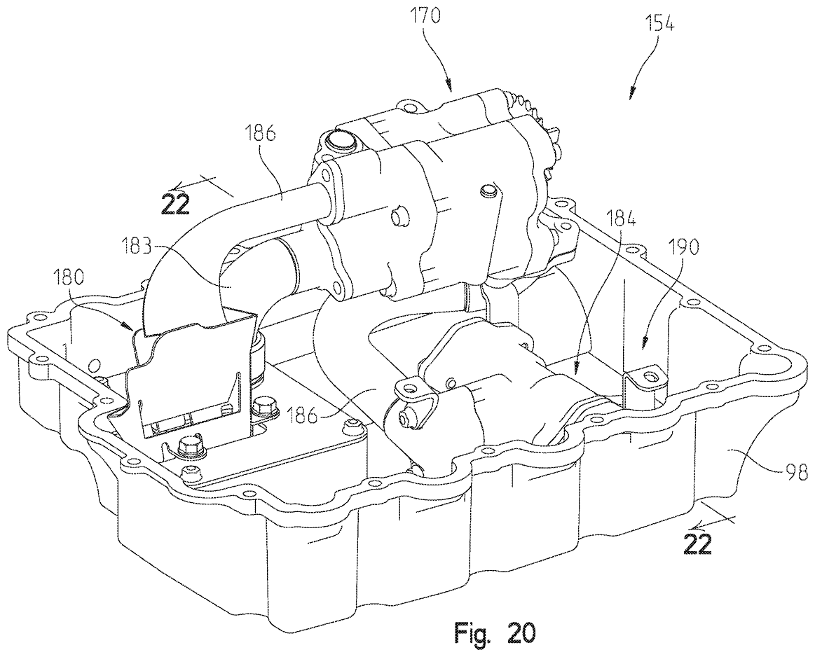

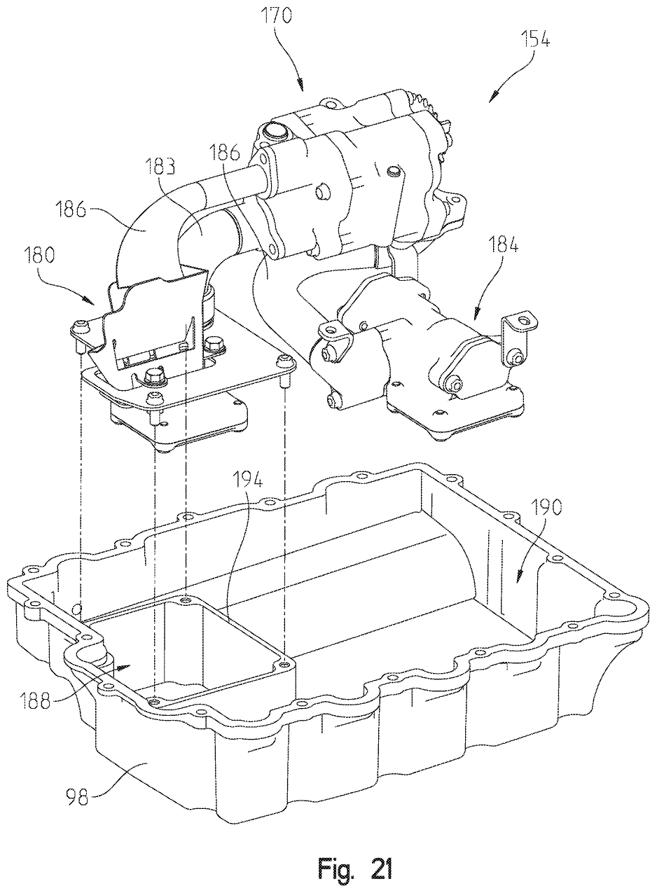

Referring to FIGS. 19-23B, lubrication system 154 generally further includes a pressure pick-up 180 fluidly coupled to oil pump 170 via a transfer conduit 182, and a scavenge pump 184 fluidly coupled to oil pump 170 via a pickup conduit 186, where pressure pick-up 180 and scavenge pump 184 are positioned within oil pan 98. Oil pan 98 generally includes a pressure pick-up volume 188 (FIG. 21) within which pressure pick-up 180 is positioned and into which oil from oil pump 170 may be released through oil pump outlet conduit 183, a scavenge pump volume 190 within which scavenge pump 184 is positioned, and an outlet 192 through which oil within oil pan 98 may be drained. In various embodiments, outlet 192 may be positioned such that oil from pressure pick-up volume 188 and scavenge pump volume 190 may be drained simultaneously. For example, outlet 192 may be positioned below a wall 194 of pressure pick-up volume 188 such that a portion of outlet 192 is in fluid communication with pressure pick-up volume 188 and a portion of outlet 192 is in fluid communication with scavenge pump volume 190.

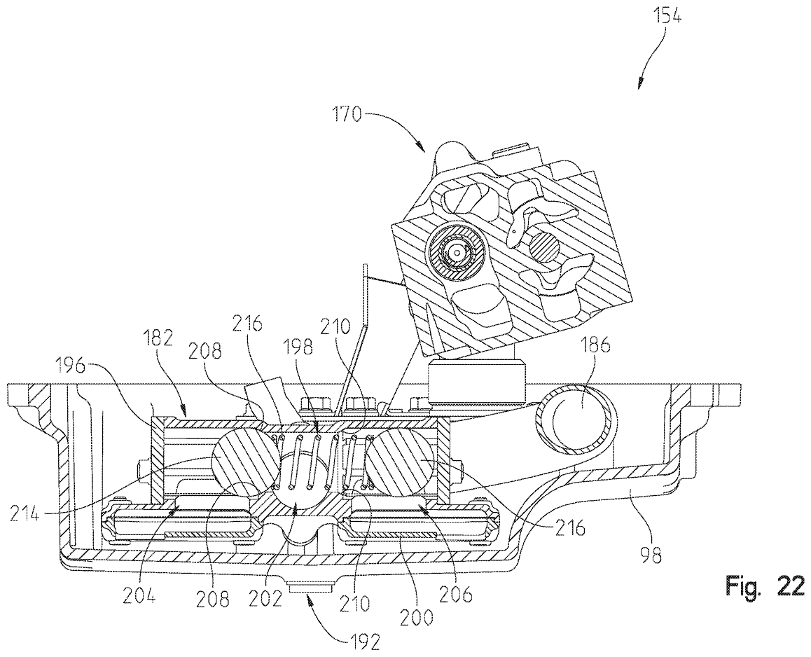

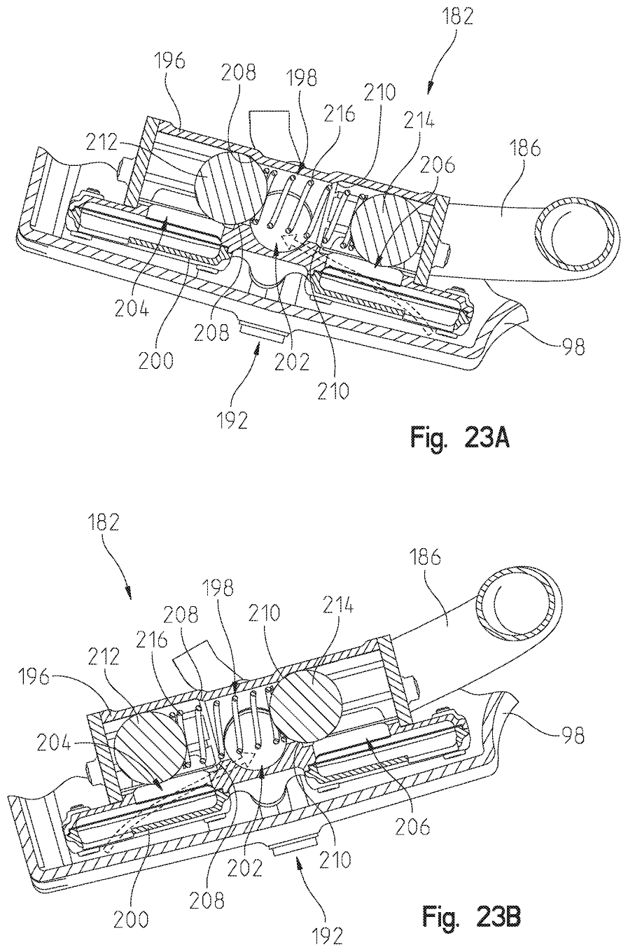

Referring to FIGS. 22, 23A, and 23B, in various embodiments, scavenge pump 184 is a shuttle valve scavenge pump 184. Shuttle valve scavenge pump 184 generally includes a housing 196, a shuttle valve assembly 198 positioned with housing 196, and a strainer assembly 200 coupled to housing 196. Housing 196 includes an outlet 202 fluidly coupled to oil pump 170 via pick up conduit 186, a first inlet 204 fluidly coupled to strainer assembly 200, a second inlet 206 fluidly coupled to strainer assembly 200, a first shoulder 208, and a second shoulder 210. Shuttle valve assembly 198 generally includes at least one ball 212 and/or 214 positioned within housing 196. In various embodiments, and as shown in the illustrative embodiments, shuttle valve assembly 198 may include a first ball 212, a second ball 214, and a spring 216 positioned between first ball 212 and second ball 214. Strainer assembly 200 generally includes a first inlet 215 in fluid communication with first inlet 204 of housing 196 and a second inlet 217 in fluid communication with second inlet 206 of housing 196.

Shuttle valve assembly 198 is configured to shift within housing 196 such that when vehicle 2 is tilted in a first direction (e.g., to one side), gravity causes the at least one ball 212 and/or 214 to prevent first inlet 215 of strainer assembly 200 and first inlet 204 of housing 196 from fluidly communicating with outlet 202 and/or oil pump 170 such that oil is received through second inlet 206 of housing 196 and second inlet 217 of strainer assembly 200. Additionally, when vehicle 2 is tilted in a second direction opposite to the first direction (e.g., to the other side), gravity causes the at least one ball 212 and/or 214 to prevent second inlet 206 of housing 196 and second inlet 217 of strainer assembly 200 from fluidly communication with outlet 202 and/or oil pump 170 such that oil is received through first inlet 215 of strainer assembly 200 and first inlet 204 of housing 196. With reference to the illustrative embodiments, when vehicle 2 is tilted in the first direction, gravity causes first ball 212 to abut first shoulder 208 such that first inlet 204 of housing 196 and first inlet 215 of strainer assembly 200 are no longer in fluid communication with outlet 202 and oil pump 170 and oil is received through second inlet 206 of housing 196 and second inlet 217 of strainer assembly 200 (FIG. 23A), while when vehicle 2 is tilted in the second direction opposite to the first direction, gravity causes second ball 214 to abut second should 210 such that second inlet 206 of housing 196 and second inlet 217 of strainer assembly 200 are no longer in fluid communication with outlet 170 and oil pump 170 and oil is received through first inlet 204 of housing 196 and first inlet 215 of strainer assembly 200 (FIG. 23B). When vehicle 2 is not tilted in either direction, the at least one ball, illustratively first ball 212 and second ball 214, may be spaced apart from first and second shoulders 208 and 210 such that oil may be received through both first and second inlets 204 and 206 of housing 196 and first and second inlets 215 and 217 of strainer assembly 200 simultaneously. However, spring 216 prevents first ball 212 and second ball 214 from being simultaneously engaged with first and second shoulder 208 and 210, respectively, such that oil is being received through one of inlets 204 and 215 or inlets 206 and 217 at any given time. As such, shuttle valve assembly 198 prevents air from being received within scavenge pump 184 when vehicle 2 is tilted.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. (canceled)

2. A utility vehicle comprising:
a frame;
a seating area supported by the frame;
front and rear ground engaging members supporting the frame; and
a powertrain drivingly coupled to the front and rear ground engaging members, the powertrain including an engine having:
a plurality of cylinders;
a plurality of intake ports including an intake port for each cylinder of the plurality of cylinders;
an intake assembly in communication with the plurality of intake ports; and
a fuel injection assembly having:
a fuel injector for each cylinder of the plurality of cylinders, the fuel injector directed toward an opposed wall of the intake assembly;
wherein the fuel injector is configured to generate a fuel stream directed toward the opposed wall; and
wherein the opposed wall of the intake assembly is configured to redirect and atomize the fuel stream into the respective intake port of the plurality of intake ports.

3. The utility vehicle of claim 2, wherein the fuel injector configured to generate the fuel stream includes the fuel injector configured to generate the fuel stream directed toward the opposed wall having a transverse angle relative to the fuel stream.

4. The utility vehicle of claim 2, wherein the opposed wall is configured to redirect and atomize the fuel stream away from the opposed wall and at a transverse angle relative to the fuel stream directed toward the opposed wall.

5. The utility vehicle of claim 2, wherein the fuel stream generated from the fuel injector is generated at an oblique angle relative to the opposed wall.

6. The utility vehicle of claim 5, wherein the oblique angle is between around 30 to around 70 degrees.

7. The utility vehicle of claim 6, wherein the oblique angle is around 45 degrees.

8. The utility vehicle of claim 2 comprising a fuel rail in communication with the fuel injection assembly, the fuel rail configured to direct fuel teach fuel injector of the fuel injection assembly.

9. The utility vehicle of claim 2, wherein one or more of the intake port or the intake assembly includes the opposed wall.

10. An engine comprising:
a cylinder block having a plurality of cylinders;
a plurality of intake ports including an intake port for each cylinder of the plurality of cylinders;
an intake assembly in communication with the plurality of intake ports; and
a fuel injection assembly having:
a fuel injector for each cylinder of the plurality of cylinders, the fuel injector directed toward an opposed wall of the intake assembly;
wherein the fuel injector is configured to generate a fuel stream directed toward the opposed wall; and
wherein the opposed wall of the intake assembly is configured to redirect and atomize the fuel stream into the respective intake port of the plurality of intake ports.

11. The engine of claim 10, wherein the fuel injector configured to generate the fuel stream includes the fuel injector configured to generate the fuel stream directed toward the opposed wall having a transverse angle relative to the fuel stream.

12. The utility vehicle of claim 11, wherein the opposed wall is configured to redirect and atomize the fuel stream away from the opposed wall and at a transverse angle relative to the fuel stream directed toward the opposed wall.

13. The utility vehicle of claim 11, wherein the fuel stream generated from the fuel injector is generated at an oblique angle relative to the opposed wall.

14. The utility vehicle of claim 13, wherein the oblique angle is between around 30 to around 70 degrees.

15. The utility vehicle of claim 14, wherein the oblique angle is around 45 degrees.

16. The utility vehicle of claim 11 comprising a fuel rail in communication with the fuel injection assembly, the fuel rail configured to direct fuel teach fuel injector of the fuel injection assembly.

17. The utility vehicle of claim 11, wherein one or more of the intake port or the intake assembly includes the opposed wall.

18. A method for atomizing fuel for an engine, the method comprising:
generating a fuel stream from a fuel injector;
directing the fuel stream toward an opposed wall of an intake assembly; and
atomizing the fuel stream with the opposed wall, atomizing including:
striking the opposed wall with the fuel stream;
redirecting the fuel stream from the opposed wall into an intake port of the engine; and
wherein the redirected fuel stream is atomized according to the striking of the opposed wall.

19. The method of claim 18, wherein directing the fuel stream toward the opposed wall of the intake assembly includes directing the fuel stream toward the opposed wall having a transverse angle relative to the fuel stream.

20. The method of claim 18, wherein generating the fuel stream from the fuel injector include generating the fuel stream at an oblique angle relative to the opposed wall.
